(19) United States
(12) Patent Application Publication
(10) Pub. No.: US 2008/0219390 A1
(43) Pub. Date: Sep. 11, 2008

(54) Receiver Circuit

(76) Inventors: Richard D. Simpson, Bedford (GB); Michael S. Harwood, Rushden (GB); Patrick W. Bosshart, Plano, TX (US)

Correspondence Address: TEXAS INSTRUMENTS INCORPORATED, P O BOX 655474, M/S 3999, DALLAS, TX, 75265, US

(21) Appl. No.: 12/028,515

(22) Filed: Feb. 8, 2008

Related U.S. Application Data
(60) Provisional application No. 60/889,106, filed on Feb. 9, 2007.

(51) Int. Cl. H04L 7/00

(52) U.S. Cl. 375/355

(57) ABSTRACT

A thermometer code to sign and magnitude converter that is particularly useful in a flash ADC is provided. This comprises two conversion units. The first is a thermometer code to Gray code converter and the second a Gray code to sign and magnitude converter. Preferably, the Gray code is of a kind that has a sign bit and has the other bits symmetrically disposed about zero. This form is easily converted to a sign and magnitude code, which is advantageous as it reduces the latency of the converter, which is particularly useful at high data rates.

This application claims priority under 35 U.S.C. 119(e)(1) to U.S. Provisional Application No. 60/889,106 (TI-63554PS) filed Feb. 9, 2007.

### BACKGROUND OF THE INVENTION

The invention relates to a receiver circuit, in particular a receiver circuit used in high speed data transfer applications.

High speed serial data transmission systems often transmit data without an accompanying clock signal. The data is input into a clock and data recovery (CDR) circuit which is used to extract a clock signal from the data. Often the approximate frequency of the required clock signal is known, but the phase is unknown. In such circumstances, a PLL at the receiver can be used, with the output of the CDR circuit being used to set the phase of the clock signal.

A variety of schemes have been devised for extracting clock information from an incoming serial data stream. Two known methods are bang-bang CDR and Mueller-Mueller CDR.

Bang-bang CDR is an example of an over-sampling CDR method. By using over-sampling, it is possible to determine the phase of the clock signals relative to the phase of the data signal and to adjust the clock signal to arrive at a sampling point that is at or close to the middle of the symbol period. In bang-bang CDR, the phase of the clock signal is incremented and decremented until a desired phase is reached.

Bang-bang CDR and other over-sampling CDR methods are not well suited for use in high-speed data transfer systems such as the SerDes system described herein due to the sampling requirements of such over-sampling methods.

Mueller-Mueller CDR is an example of a baud rate CDR method; that is, a CDR method that samples data at the baud rate (one sample per bit period). This allows baud rate CDR methods, such as Mueller-Mueller CDR, to be used at very high data rates.

A problem with Mueller-Mueller CDR is that it is not able to detect the phase of a clock signal from an incoming data stream if that data is unchanging (i.e. 000 . . . 000 or 111 . . . 111) or if the incoming data is a clock, or clock-like signal (i.e. 10101010). It should be noted that bang-bang CDR algorithms also have problems in detecting the phase of data that is unchanging.

As outlined above, over-sampling CDR methods, such as bang-bang CDR, are unsuitable for sampling data streams having a very high data rate. Baud rate CDR methods, such as Mueller-Mueller CDR are well suited for sampling data streams having a very high data rate. In any particular application, either an over-sampling CDR method or a baud rate CDR method is likely to be more appropriate. Accordingly, schemes such as bang-bang CDR and Mueller-Mueller CDR are not generally considered to be alternatives.

### SUMMARY OF THE INVENTION

The present invention provides a serialisation-deserialisation receiver circuit comprising a data input terminal, a select input terminal, an over-sampling clock recovery system and a baud rate clock recovery system, wherein said over-sampling clock recovery system and said baud rate clock recovery system are adapted such that one of said over-sampling clock recovery system and said baud rate clock recovery system provides a clock output in dependence on a select input.

The present invention also provides a method of recovering a clock signal in a serialisation-deserialisation receiver circuit, the method comprising the steps of using either a over-sampling clock recovery system or a baud rate clock recovery system to recover said clock in dependence on a signal received at a select input of said circuit.

By providing both baud rate and over-sampling clock recovery options, the receiver circuit of the present invention is compatible with legacy systems. The system is also extremely flexible. It should be noted that the legacy support of the over-sampling clock recovery option can only occur up to half the data rate that is available for the baud rate clock recovery option, due to the need to over-sample the data. Further, it should be noted that for some data patters, the over-sampling approach may give superior jitter tracking performance compared with some baud rate options; accordingly, an over-sampling clock recovery option may be preferable at lower data rates. The invention may provide, in a single design, clock recovery for signals compliant with lower rate standards such as XAUI (3.125 Gb/s), PCIExpress (5 Gb/s) and SR10 gen2 (5 Gb/s) using bang-bang, as well as those compliant with faster standards such as CEI 6G (11 Gb/s) and IEEE 802.3 (10.3125 Gb/s) using Mueller-Mueller.

The over-sampling clock recovery system may be a bang-bang clock recovery system. The baud rate clock recovery system may be a Mueller-Mueller clock recovery system. The skilled person would, however, be aware of alternative clock recover systems that could be used.

In one form of the invention, an analogue-digital converter is provided having an input coupled to said data input terminal and an output coupled to inputs of said over-sampling clock recovery system and said baud rate clock recovery system. By way of example, the analogue-digital converter may comprise two full-flash analogue-digital converters adapted to sample and convert alternate bits of the data received at said data input terminal. The use of two analogue-digital converters in this manner enables data to be sampled at a very high clock rate. The analogue-digital converter may have a sampling point that is set by said clock output; for example, said clock output may be coupled to a clock input of said analogue-digital converter.

In one form of the invention, an equalizer is provided having an input coupled to said data input terminal and an output coupled to the inputs of said over-sampling and baud rate clock recovery circuits. For example, the equalizer may receive the output of the analogue-digital converter.

In one form of the invention, the equalizer comprises a feed-forward equalizer. In one form of the invention, the equalizer comprises a decision feedback equalizer.

The equalizer may determine a slicing level of said analogue-digital converter.

### BRIEF DESCRIPTION OF THE DRAWINGS

Examples of the invention will now be described with reference to the accompanying drawings, of which:

FIG. 1 is a block diagram of a receiver circuit, in which the invention may be used;

FIG. 2 shows the feed forward equaliser and the decision feedback equaliser of the receiver circuit of FIG. 1;

FIG. 3 is a graph showing the post equalised signal amplitude for exemplary bit patterns;

FIG. 4 is a diagram of a transmitter, with which the invention may be used;

FIG. 5a shows the response of the receiver to a PRBS transmitted eye-pattern;

FIG. 5b shows the interleaved output of the ADCs of the receiver;

FIG. 6 is a block diagram of a clock recovery system in accordance with an aspect of the present invention;

FIG. 7 is a graph demonstrating a feature of bang-bang CDR in accordance with an aspect of the present invention;

FIG. 8 is a timing diagram demonstrating a feature of bang-bang CDR in accordance with an aspect of the present invention;

FIG. 9a is a graph demonstrating a feature of Mueller-Mueller CDR in accordance with an aspect of the present invention;

FIG. 9b is a graph demonstrating a feature of Mueller-Mueller CDR in accordance with an aspect of the present invention; and

FIG. 9c is a graph demonstrating a feature of Mueller-Mueller CDR in accordance with an aspect of the present invention.

### DETAILED DESCRIPTION OF THE PREFERRED EMBODIMENTS

A key challenge facing designers of high-bandwidth systems such as data-routers and super-computers is the requirement to transfer large amounts of data between ICs—either on the same circuit board or between boards. This data transmission application is called Serialisation-Deserialisation or “SerDes” for short. The present invention is useful in SerDes circuit and indeed was developed for that application. Nonetheless the invention may be used in other applications.

Analysis of typical backplane channel attenuation (which is around −24 dB) and package losses (−1 to −2 dB) in the presence of crosstalk predict that an un-equalized transceiver provides inadequate performance and that decision feedback equalization (DFE) is needed to achieve error rates of less than 10⁻¹⁷.

Traditional decision-feedback equalization (DFE) methods for SerDes receivers rely on either modifying, in analogue, the input signal based on the data history [“A 6.25 Gb/s Binary Adaptive DFE with First Post-Cursor tap Cancellation for Serial backplane Communications” R Payne et al ISSCC 2005; “A 6.4 Gb/s CMOS SerDes Core with feed-forward and Decision Feedback Equalization” M. Sorna et al ISSCC 2005; “A 4.8-6.4 Gb/s serial Link for Backplane Applications Using Decision Feedback Equalization” Balan et al IEEE JSSC November 2005.] or on having an adaptive analogue slicing level [“Techniques for High-Speed implementation of Non-linear cancellation” S. Kasturia IEEE Journal on selected areas in Communications. June 1991.] (i.e. the signal level at which the circuit decides whether the signal represents a 1 or a 0).

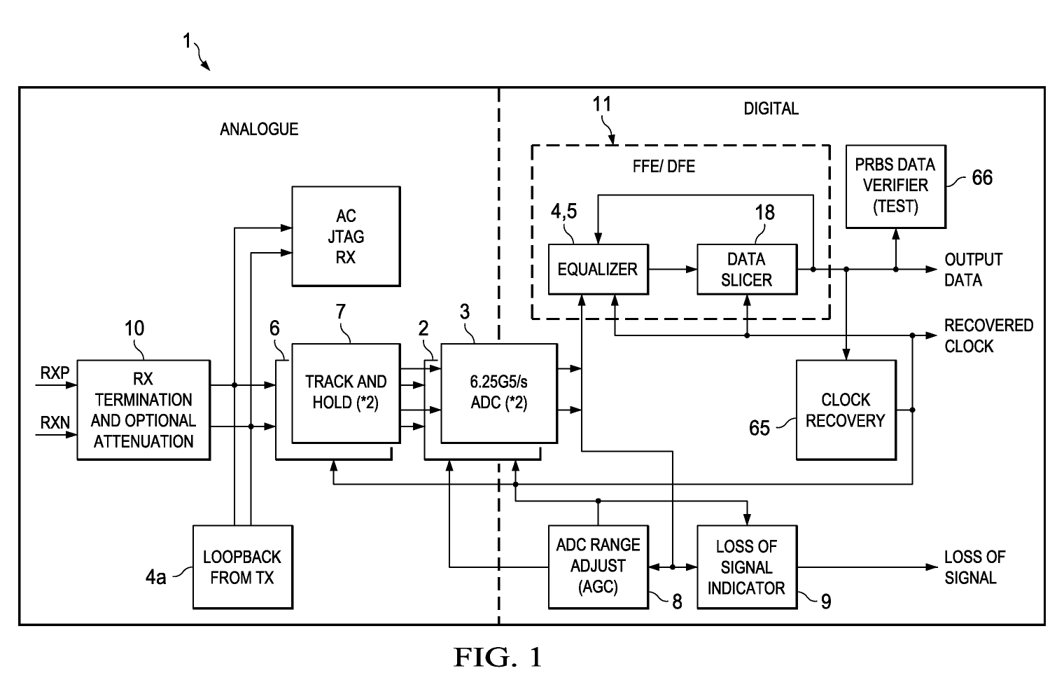

A block diagram of a SerDes receiver circuit 1, which forms part of an integrated circuit, in which the present invention may be used is shown in FIG. 1. The invention may nonetheless be used in other applications.

In the receiver circuit 1 of FIG. 1 the input data is sampled at the baud-rate, digitized and the equalization and clock & data recovery (CDR) performed using numerical digital processing techniques. This approach results in the superior power/area scaling with process of digital circuitry compared to that of analogue, simplifies production testing, allows straightforward integration of a feed-forward equalizer and provides a flexible design with a configurable number of filter taps in the decision feedback equaliser. The circuit has been implemented in 65 nm CMOS, operating at a rate of 12.5 Gb/s.

The receiver circuit 1 comprises two baud-rate sampling ADCs (analogue to digital converters) 2 and 3, a digital 2-tap FFE (feed forward equaliser) 4 and digital 5-tap DFE (decision feedback equaliser) 5 to correct channel impairments.

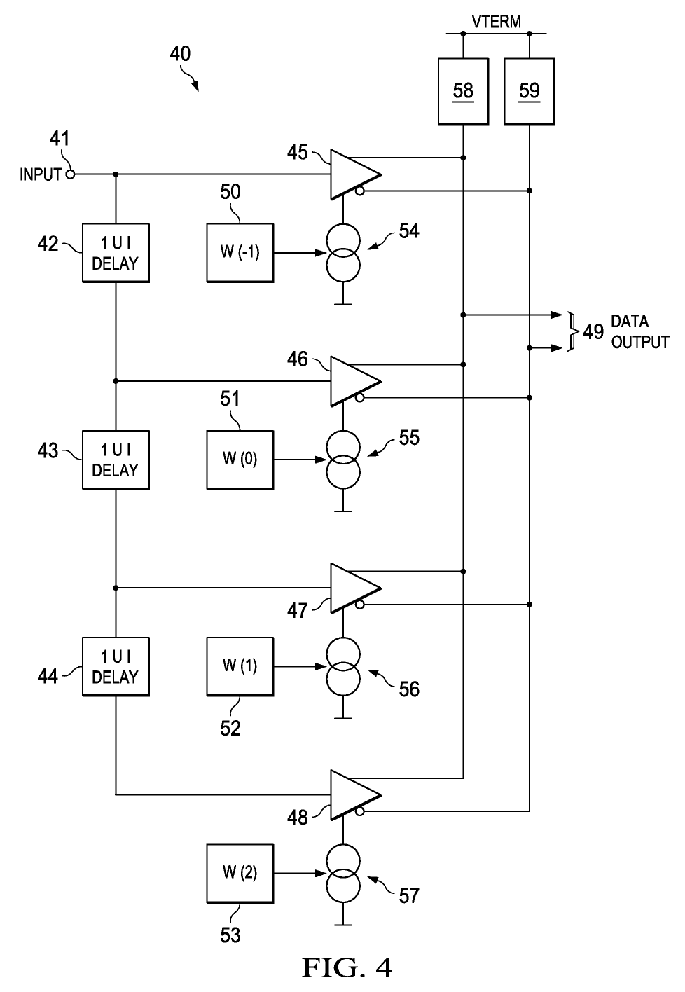

The SerDes section of the integrated circuit, which includes the receiver circuit 1 is also provided with a transmitter 40 (FIG. 4), connected to transmit data over a parallel channel to that which the receiver circuit 1 is connected to receive data. The transmitter 40 comprises a 4-tap FIR filter to pre-compensate for channel impairments. In many applications the integrated circuit transmitting data to the receiver circuit 1 uses pre-compensation and in particular a similar transmitter circuit 40, but in other applications the receiver circuit 1 works without pre-compensation being used at the other end

The receiver 1 of FIG. 1 is now described in more detail. The received data is digitized at the baud-rate, typically 1.0 to 12.5 Gb/s, using a pair of interleaved track and hold stages (T/H) 6 and 7 and a respective pair of 23 level (4.5 bit) full-flash ADCs 2 and 3 (i.e. they sample and convert alternate bits of the received analogue data waveform). The two track & hold circuits enable interleaving of the half-rate ADCs and reduce signal related aperture timing errors. The two ADCs, each running at 6.25 Gb/s for 12.5 Gb/s incoming data rate provide baud-rate quantization of the received data. The ADC's dynamic range is normalized to the full input amplitude using a 7-bit automatic gain control (AGC) circuit 8. A loss of signal indication is provided by loss of signal unit 9 that detects when the gain control signal provided by the AGC is out-of-range. An optional attenuator is included in the termination block 10, which receives the signals from the transmission channel, to enable reception of large signals whilst minimizing signal overload.

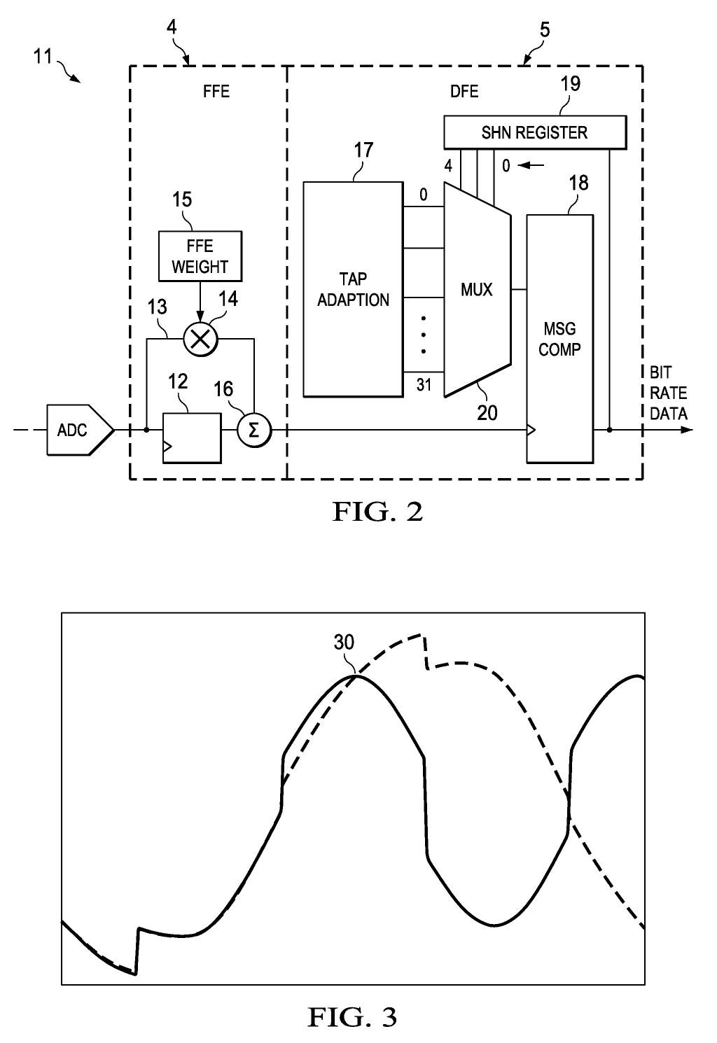

The digital samples output from the ADCs 2 and 3 are interleaved and the resulting stream of samples is fed into a custom digital signal processing (DSP) data-path that performs the numerical feed-forward equalization and decision-feedback equalization. This is shown in FIG. 2. This comprises a 1 UI delay register 12 connected to receive the stream of samples from the ADCs 2 and 3. (1 UI is a period of the clock, i.e. the delay between bits.) A tap 13 also feeds the samples from the ADCs to a multiplier 14, each sample being received by the delay latch 12 and the multiplier 14 at the same time. The multiplier 14 multiplies each sample by a constant weight value (held in a programmable register 15), which value is typically 10%. The outputs of the multiplier 14 and the delay register 12 are added together by an adder 16 to provide the output of the FFE 4.

The digital FFE/DFE is implemented using standard 65 nm library gates.

An advantage of applying the equalization digitally is that it is straightforward to include feed-forward equalization as a delay-and-add function without any noise-sensitive analogue delay elements. The FFE tap weight is selected before use to compensate for pre-cursor ISI and can be bypassed to reduce latency. Whilst many standards require pre-cursor de-emphasis at the transmitter, inclusion at the receiver allows improved bit error rate (BER) performance with existing legacy transmitters.

The DFE 5 uses an unrolled non-linear cancellation method [“Techniques for High-Speed implementation of Non-linear cancellation” S. Kasturia IEEE Journal on selected areas in Communications. June 1991]. The data output (i.e. the 1s and 0s originally transmitted) is the result of a magnitude comparison between the output of the FFE 4 and a slicer-level dynamically selected from a set stored in a set 17 of pre-programmed registers. The values are determined by a control circuit (not shown in FIG. 1) from the waveforms of test patterns sent during a setup phase of operation. The magnitude comparison is performed by a magnitude comparator 18 connected to receive the output of the FFE 4 and the selected slicer-level; it outputs a 1 if the former is higher than the latter and a 0 if it is lower or equal, thereby forming the output of the DFE 5.

The slicer-level is selected from one of 2n possible options depending on the previous n bits of data history. The history of the bits produced by the magnitude comparator 18 is recorded by a shift register 19 which is connected to shift them in. The parallel output of the shift register is connected to the select input of a multiplexer 20 whose data inputs are connected to the outputs of respective ones of the set 17 of registers holding the possible slicer-levels.

Unrolled tap adaption is performed using a least mean square (LMS) method where the optimum slicing level is defined to be the average of the two possible symbol amplitudes (+/−1) when proceeded by identical history bits. (For symmetry the symbols on the channel for the bit values 1 and 0 are given the values +1 and −1).

Although 5-taps of DFE were chosen for this implementation, this parameter is easily scaleable and performance can be traded-off against power consumption and die area. In addition, the digital equalizer is testable using standard ATPG (automatic test pattern generation) and circular built-in-self-test approaches.

The chosen clock recovery approach uses a Muller-Mueller approach [“Timing recovery in Digital Synchronous Data Receivers” Mueller and Muller IEEE Transactions on Communications May 1976.] where the timing function adapts the T/H sample position to the point where the calculated pre-cursor inter-symbol interference (ISI) or h(−1) is zero, an example being given in FIG. 3. The two curves show the post-equalized response for 010 and 011 data sequences respectively. The intersection 30 at 3440 ps occurs when the sample of the second bit is independent of the third bit—that is, h(−1)=0. This position can be detected by comparing the post-equalized symbol amplitude with the theoretical amplitude h(0) and using the difference to update the CDR's phase-interpolator.

A block diagram of the transmitter is shown in FIG. 4, which is implemented using CML techniques. The data to be transmitted (received at terminal 41) is sequentially delayed by three 1 UI delay registers 42, 43 and 44 connected in series. They produce, via the four taps before and after each delay, a nibble-wide word containing the pre-cursor, cursor and two post-cursor components. In fact to ease timing closure the data is sent to the transmitter from the digital part of the circuit that supplies the data in blocks of 4 nibbles (16 bits in parallel), the blocks being sent at a rate of 3.125/s. Each nibble is a frame of four bits of the bitstream offset by one bit from the next so the nibbles overlap and represent the data redundantly. A multiplexer then selects one of the nibbles, switching between them at a rate of 12.5×10⁹/s, and presents that in parallel to the four taps, thereby making the bitstream appear to advance along the taps.

A 4-tap FIR output waveform is obtained from simple current summing of the time-delayed contributions. This is done with differential amplifiers 45 to 48, each having its inputs connected to a respective one of the taps and having its differential output connected to a common differential output 49. Although shown as four differential amplifiers the circuit is implemented as one differential amplifier with four inputs, which minimizes return-loss. The relative amplitude of each contribution is weighted to allow the FIR coefficients to be optimized for a given circuit (e.g. a backplane) and minimize the overall residual ISI. The weights are determined empirically either for a typical example of a particular backplane or once a backplane is populated and are stored in registers 50 to 53. The weights respectively control the controllable driving current sources 54 to 57 of the differential amplifiers 45 to 48 to scale their output current accordingly. Respective pull-up resistors 58 and 59 are connected to the two terminals of the differential output 49.

A PLL is used to generate low-jitter reference clocks for the transmitter and receiver to meet standards [“OIF-CEI-02.0—Common Electrical I/O (CEI)—Electrical and Jitter Interoperability agreements for 6G+ bps and 11G+ bps I/O”. Optical Internetworking Forum, February 2005; “IEEE Draft 802.3ap/Draft 3.0—Amendment: Electrical Ethernet Operation over Electrical Backplanes” IEEE July 2006.]. Most integrated circuits will have more than one receiver 1 and the PLL is shared between them with each receiver having a phase interpolator to set the phase to that of incoming data.

The PLL uses a ring oscillator to produce four clock-phases at a quarter of the line data-rate. The lower speed clocks allow power efficient clock distribution using CMOS logic levels, but need duty-cycle and quadrature correction at the point of use. The 3.125 GHz clocks are frequency doubled (XOR function) to provide the 6.25 GHz clock for the T/H & ADC. The transmitter uses the four separate 3.125 GHz phases, but they require accurate alignment to meet jitter specifications of 0.15UI p-p R.J. and 0.15UI p-p D.J.

The system described has been fabricated using a 65 nm CMOS process and has been shown to provide error-free operation at 12.5 Gb/s over short channels (two 11 mm package traces, 30 cm low-loss PCB and two connectors). A legacy channel with −24 dB of attenuation at 3.75 GHz supports error free operation at 7.5 Gb/s.

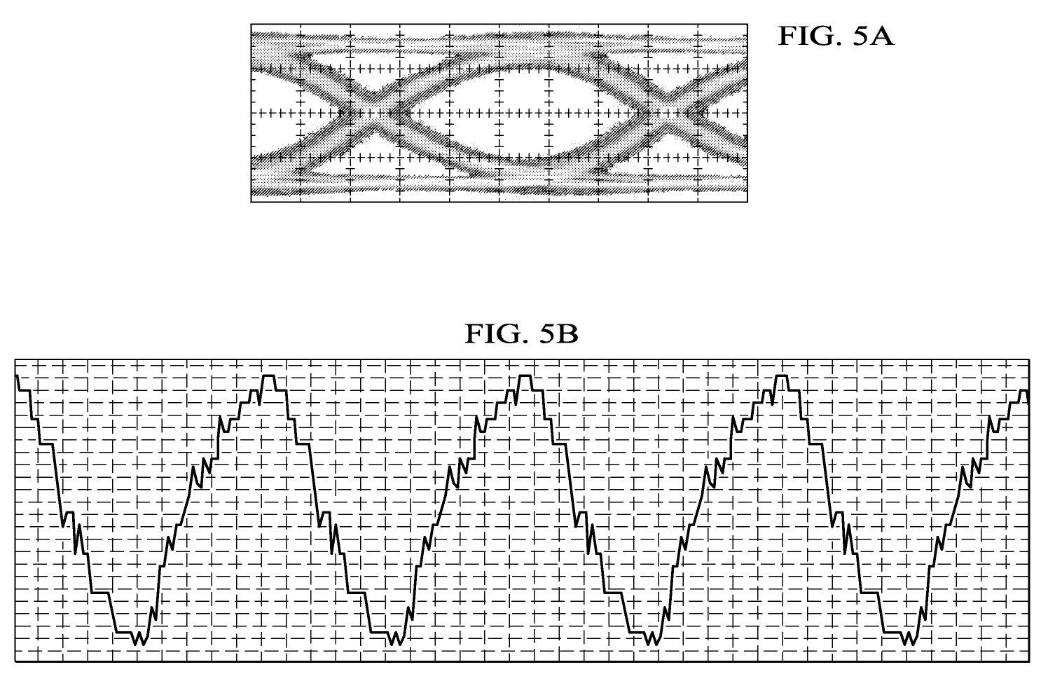

FIG. 5a shows a 12.5 Gb/s 27-1 pseudo random bit stream (PRBS) transmitted eye-pattern with 20% de-emphasis on the first post-cursor. The receiver includes, for test purposes, a PRBS data verifier 66, which confirms that the test pattern has been received. The differential peak-to-peak (pp) amplitude is 700 mV (200 mV/div). FIG. 5b shows the ADC output when a 6.25 GHz sine-wave is sampled and the phase between the sine-wave and receiver is incremented using a programmable delay-line. The measured codes are within +/−1 lsb (least significant bit) of the expected values. This level of performance ensures robust operation over a wide range of cables, green-field and legacy channels. The worst-case power of a single TX/RX pair, or “lane” is 330 mW and the total exemplary macro area is 0.45 mm² per lane (allowing for the PLL being shared by four TX/RX lanes.

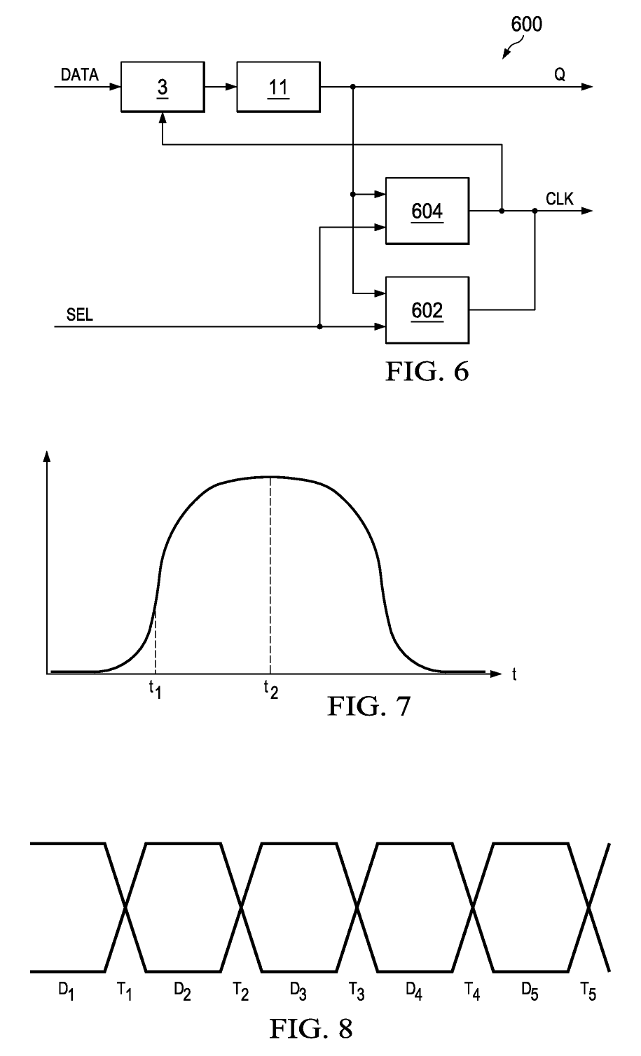

FIG. 6 shows a clock recovery system, indicated generally by the reference numeral 600, in accordance with an embodiment of the present invention.

The clock recovery system 600 comprises an analogue data input DATA, an analogue-digital converter (ADC) 3, an equalizer circuit 11, a select input SEL, a bang-bang CDR circuit 602, a Mueller-Mueller CDR circuit 604, a data output Q and a clock output CLK.

The ADC 3 and the equalizer 11 are those described above with reference to FIG. 1. Thus the equalizer 11 is able to perform both feed-forward equalization (FFE) and decision feedback equalization (DFE).

The incoming analogue data is converted into digital data by the ADC 3. The equalizer circuit 11 provides the data output Q in the manner described above with reference to FIG. 1. The data Q is also passed to the inputs of bang-bang CDR circuit 602 and Mueller-Mueller CDR circuit 604. The select input SEL is routed to both the bang-bang clock and data recovery circuit 602 and the Mueller-Mueller clock and data recover circuit 604.

In use, one of the bang-bang clock and data recovery circuit 602 and the Mueller-Mueller clock and data recover circuit 604 is used to recover a clock from the data received at the data input D in dependence on the signal received at the select input SEL. The data and clock output by the selected data and clock recover circuit is used to form the data and clock outputs of the circuit 600. The clock signal CLK is also used to control the sample point of the ADC 3.

FIG. 7 shows an exemplary data input of the circuit 600 that is suitable for clock recovery by the bang-bang method. In the example of FIG. 7, the data sequence 010 is received. As shown in FIG. 7, the data is sampled at time t₁ and time t₂. The phase at which the samples are taken can readily be adjusted by adjusting the phase input to the PLL that is generating the clock singles.

In the example of FIG. 7, the ideal sampling point in the high voltage section indicative of a logic “1” is at time t₂. In the 2-times over-sampling regime shown in FIG. 7, the sampling point t₂ can be set by setting the previous sampling time (t₁) at the point of data transition.

When data is sampled at a data transition time, that sample may detect the data as being either ‘0’ or ‘1’. Accordingly, in one form of the invention, the sample periods are set such that at data transitions, the incoming data is deemed to be ‘0’ approximately as often as it is deemed to be ‘1’.

FIG. 8 is an exemplary timing diagram showing how the phase of the sampling signals is adjusted in an embodiment of the present invention.

FIG. 8 shows a number of data samples separated by data transitions. As shown in FIG. 8, the first data sample is sampled at a time D1. Similarly, the second, third, fourth and fifth data samples are sampled at times D2, D3, D4 and D5 respectively. The first data transition (that between the first and second data samples) is sampled at a time T1. Similarly, the second, third, fourth and fifth data transitions are sampled at times T2, T3, T4 and T5 respectively.

Each data sample is compared with the previous data sample to determine whether or not a data transition has occurred. If a data transition has occurred, then the value of the transition sample is noted. In each case, if the transition bit has the same data value as the earlier of the two data samples, then the transition is deemed to have been sampled too early. Conversely, if the transition bit has the same data value as the later of the two data samples, then the transition is deemed to have been sampled too late.

By way of example, consider the following data stream (starting with D1): 001001101.

Transition samples are taken between each of the data samples. Assume now that the transition samples (starting with T1, which is the transition between D1 and D2) are as follows: 00101110.

The data and transition samples are listed in the following table:

| | DATA | TRANSITION |
|---|---|---|
| TIME | SAMPLE | SAMPLE |
| D1 | 0 | |
| T1 | | 0 |
| D2 | 0 | |
| T2 | | 0 |
| D3 | 1 | |
| T3 | | 1 |
| D4 | 0 | |
| T4 | | 0 |
| D5 | 0 | |
| T5 | | 1 |
| D6 | 1 | |
| T6 | | 1 |
| D7 | 1 | |
| T7 | | 1 |
| D8 | 0 | |
| T8 | | 0 |
| D9 | 1 | |

In the table above, the data D changes state between D2 and D3, D3 and D4, D5 and D6, D7 and D8, and D8 and D9. Thus, the relevant transition data are T2, T3, T5, T7 and T8.

As can be seen from the table, T2=D2 such that, by the time T2, the data has not changed and so the transition sample is deemed to be early. Similarly, T3=D3, T7=D7 and T8=D8. Thus, each of transition samples T2, T3, T7 and T8 is deemed to be early.

Conversely, T5=D6. Accordingly, transition sample T5 is deemed to be late.

Since there are four transition samples that are deemed to be early and one that is deemed to be late, the overall sampling time is deemed to be early and the phase of the samples can be incremented to sample later. In this manner, the sample time is adjusted to keep the transition early/late ratio close to 50%.

In this way, the number of early and late transition samples is averaged over a period of time, and the phase of the transition samples is adjusted until the number of late samples is approximately equal to the number of early samples. In a 2-times over-sampling arrangement such as that shown in FIG. 8, the data samples are separated by half a data cycle from the transition cycle. Accordingly, adjusting the transition sample time results in a similar adjustment of the data sample time.

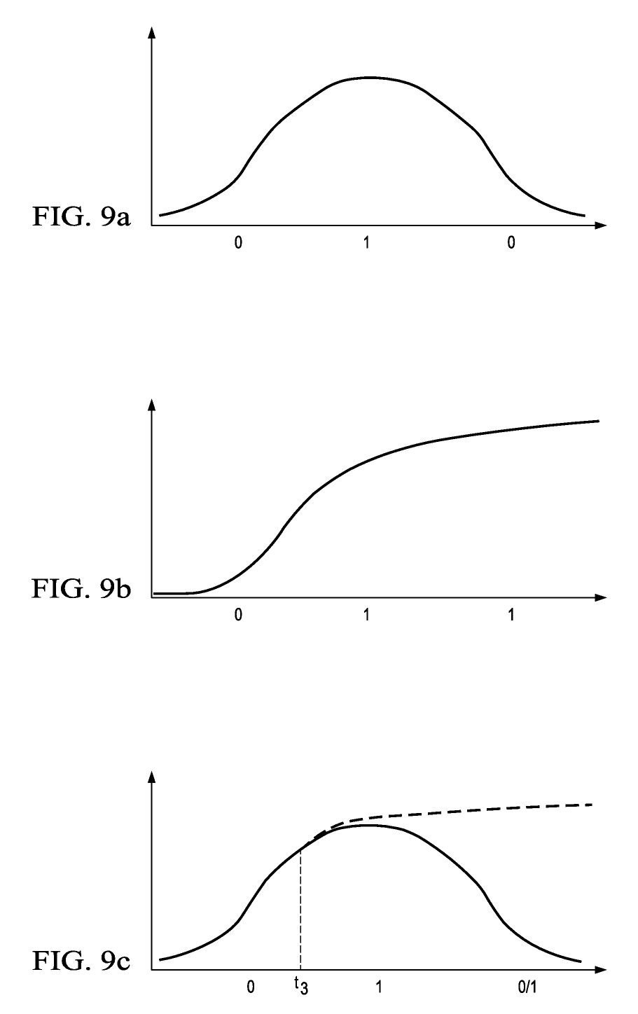

FIG. 9 shows exemplary data inputs of the circuit 600 that is suitable for clock recovery by the Mueller-Mueller method. In the example of FIG. 9a, the data sequence 010 is received. In the example of FIG. 9b, the data sequence 011 is received. The example of FIG. 9c includes both data sequence 010 and data sequence 011.

As shown in FIG. 9a, a data sequence 010 appears as low voltage that rises (in response to the data ‘1’) and then falls. In the example of FIG. 9a, the data rate is sufficiently high that clear data transitions do not occur. This is typically the case in applications where Mueller-Mueller CDR is used.

As shown in FIG. 9b, a data sequence appears as a low voltage that rises (in response to the data ‘1’) and then continues to rise (in response to the second data ‘1’).

FIG. 9c incorporates the data sequences 010 and 011 on the same time line. As shown in FIG. 9c, due to pre-cursor inter-symbol interference, the rising signal due to the second of the data ‘1’ signals (shown as a dotted line) is above the level of the signal for the input 010 during the period in which the first logic ‘1’ is being received.

In one form of the invention, the data is sampled at the point at which the inter-symbol interference (ISI) is zero (i.e. the pre-cursor contribution to the overall data amplitude is zero). That point is marked as t₃ in the example of FIG. 9c. Those skilled in the art will know that other forms of Mueller-Muller CDR are known. For example, the data may be sampled at the point at which h(0)=nh(−1), that is, where the signal level from the current sample is several times greater than the signal level from the previous sample. In one implementation of the invention, n=8, such that the signal level from the current sample is eight times greater than the signal level from the previous sample. It should be noted that 8 is a convenient case for digital implementation, since the division can be implemented via a simple binary shift.

What is claimed is:

1. A serialisation-deserialisation receiver circuit comprising a data input terminal, a select input terminal, an over-sampling clock recovery system and a baud rate clock recovery system, wherein said over-sampling clock recovery system and said baud rate clock recovery system are adapted such that one of said over-sampling clock recovery system and said baud rate clock recovery system provides a clock output in dependence on a select input.

2. A circuit as claimed in claim 1, wherein said over-sampling clock recovery system is a bang-bang clock recovery system.

3. A circuit as claimed in claim 1, wherein said baud rate clock recovery system is a Mueller-Mueller clock recovery system.

4. A circuit as claimed in claim 1, further comprising an analogue-digital converter having an input coupled to said data input terminal and an output coupled to inputs of said over-sampling clock recovery system and said baud rate clock recovery system.

5. A circuit as claimed in claim 4, wherein said analogue-digital converter comprises two full-flash analogue-digital converters adapted to sample and convert alternate bits of the data received at said data input terminal.

6. A circuit as claimed in claim 4, wherein a sampling point of said analogue-digital converter is set by said clock output.

7. A circuit as claimed in claim 1, further comprising an equalizer having an input coupled to said data input terminal and an output coupled to the inputs of said over-sampling and baud rate clock recovery circuits.

8. A circuit as claimed in claim 7, wherein the input of said equalizer is adapted to receive the output of said analogue-digital converter.

9. A circuit as claimed in claim 7, wherein said equalizer comprises a feed-forward equalizer.

10. A circuit as claimed in claim 7, wherein said equalizer comprises a decision feedback equalizer.

11. A circuit as claimed in claim 10, wherein said equalizer determines a slicing level of said analogue-digital converter.

12. A method of recovering a clock signal in a serialisation-deserialisation receiver circuit, the method comprising the steps of using either a over-sampling clock recovery system or a baud rate clock recovery system to recover said clock in dependence on a signal received at a select input of said circuit.
